(19) United States
(12) Patent Application Publication
(10) Pub. No.: US 2015/0365383 A1
(43) Pub. Date: Dec. 17, 2015

(54) ENERGY SERVICE DELIVERY PLATFORM

(71) Applicant: Commonwealth Scientific and Industrial Research Organisation, Campbell (AU)

(72) Inventor: Martin DE GROOT, Hobart (AU)

(21) Appl. No.: 14/834,645

(22) Filed: Aug. 25, 2015

Related U.S. Application Data
(63) Continuation of application No. 13/699,360, filed on Mar. 11, 2013, now abandoned.

(30) Foreign Application Priority Data
May 21, 2010 (AU) 2010902216

(51) Int. Cl. H04L 29/06; H04L 12/911; H04L 9/08

(52) U.S. Cl. CPC H04L 63/0428; H04L 9/0894; H04L 47/783; H04L 2209/24

(57) ABSTRACT

A resource management client apparatus (102) comprises an interface to a wide area network (WAN, 106) facilitating connection to a resource management server (104), and at least one communications interface (116, 118) configured to communicate with a plurality of resource monitoring and control devices (120, 122) associated with the resource management client apparatus (102). A secure key interface (128) is configured to receive an electronic access device (130) that securely stores information including at least a unique identifier, resource management server connection data, and one or more encryption keys for encrypting information transmitted between the resource management client apparatus (102) and the resource management server (104). The resource management client apparatus (102) establishes a connection to the resource management server (104) via the WAN (106), using the resource management server connection data stored in the electronic access device (130). It receives status messages from the resource monitoring and control devices (120, 122) via the communications interfaces (116, 118). It also processes received status messages, and encrypts and transmits corresponding status information of the resource monitoring and control devices (120, 122) to the resource management server (104) via the WAN (106). It also receives and decrypts encrypted resource control information from the resource management server (104) via the WAN (106). Furthermore, it processes received resource control information and transmits corresponding control messages to the resource monitoring and control devices (120, 122). The apparatus (102), and associated devices and components, facilitate the provision of a self-configuring universal energy management solution.

This application is a Continuation of U.S. Ser. No. 13/699,360, filed 11 Mar. 2013, which is a National Stage Application of PCT/AU2011/000594, filed 19 May 2011, which claims benefit of Serial No. 2010902216, filed 21 May 2010 in Australia and which applications are incorporated herein by reference. To the extent appropriate, a claim of priority is made to each of the above disclosed applications.

### FIELD OF THE INVENTION

The present invention relates to resource management, and more particularly to a platform that in preferred embodiments comprises methods, apparatus and systems for managing energy resources, such as electrical loads and generators, located at multiple geographically distributed sites.

### BACKGROUND OF THE INVENTION

Large energy consumers have strong financial incentives to invest in sophisticated energy management projects. Some large consumers, for example, may manage their own energy consumption, employing dedicated staff and/or contracting consultants to implement energy management plans and infrastructure. In recent times, ie over the last two or three decades, new players have started to emerge servicing this need in the energy sector, generally known as Energy Services Companies (ESCOs).

In broad terms, many ESCOs act as virtual retailers, purchasing electricity from suppliers on behalf of their clients, and providing energy management services for those clients. In alternative models, ESCOs may operate outside the normal electricity market, for example by selling services based upon their management of client energy resources and passing on a portion of the income as payment to their clients.

In any event, ESCOs are able to work with large energy consumers to reduce costs through greater efficiency, and by aligning consumption with market signals. For example, in the Australian National Electricity Market (NEM), a wholesale spot market is operated enabling the purchase of electricity half-an-hour ahead of time. The spot price is highly dynamic, changing in response to supply and demand, and may be updated as frequently as once every five minutes. Large energy consumers that have flexibility in the times and/or level of energy consumption are able to alter their demands responsive to the spot price, reducing their costs, and contributing to overall improvements in the efficiency of operation of the entire energy system. ESCOs are able to fulfil a useful role in relation to this so-called “demand-side response”, for example by managing their client's energy consumption and effectively “selling” reductions in demand during

peak usage times back to energy suppliers, which are in turn able to reduce the level of reserve capacity maintained for supplying demand peaks.

ESCOs are also able to act as project developers in respect of projects targeting improvements in energy efficiency and reducing maintenance costs over extended periods of time. Various measures may be employed in ESCO projects in order to achieve energy savings, including the use of high-efficiency lighting, heating, air conditioning, and other appliances, and the provision and operation of centralised energy management systems. Typically, therefore, ESCO projects require a large initial capital investment, which is recovered over a relatively long operating period. The cost of the initial investment is repaid through energy savings, and the ESCO often assumes the risk associated with the initial savings projections. Most such performance-based energy efficiency projects include maintenance of equipment over the project life cycle, which is incorporated into the overall cost of the project.

Based upon this brief summary of ESCO activities, it will be apparent that, at present, small-scale energy consumers do not have the same opportunity to achieve efficiencies and cost savings through the services provided by ESCOs, since the financial benefit would not offset the capital investment and maintenance costs. Using available solutions for single-site electricity management, even relatively modest retrofits require modifications to existing wiring, specialised device control hardware, and/or provide for only partial monitoring and control of site electricity consumption. In particular, energy management proposals based upon installing local generation and/or intelligent home automation systems may be expensive, ineffective and poorly suited to retrofitting in older houses and business premises. Nonetheless, electricity consumption by small-scale consumers, such as residential and small business sites, is characterised by very large numbers of widely distributed devices, with regulated tariffs, and a disproportionate impact on peak network demand. It is expected that this situation will only be exacerbated by anticipated advances in technology and changing lifestyles. For example, electric vehicles may represent a profound change in the way that electricity grids will operate, since most such vehicles will be connected to the grid at numerous residential sites.

There is, accordingly, an increasingly pressing need to provide cost-effective energy management strategies and systems that may be practically deployed throughout the current stock of small residential and business sites throughout major population centres. Similar requirements arise in relation to other resources, such as gas and water. The present invention seeks to address this need.

### SUMMARY OF THE INVENTION

In one aspect, the present invention provides a resource management client apparatus comprising:

an interface to a wide area network (WAN) facilitating connection to a resource management server;

at least one communications interface configured to communicate with a plurality of resource monitoring and control devices associated with the resource management client apparatus;

a secure key interface configured to receive an electronic access device that securely stores information including at least a unique identifier, resource management server connection data, and one or more encryption keys for encrypting information transmitted between the resource management client apparatus and the resource management server,

wherein the resource management client apparatus is configured to:

establish a connection to the resource management server via the WAN, using the resource management server connection data stored in the electronic access device;

receive status messages from the resource monitoring and control devices via the communications interface;

process received status messages, and encrypt and transmit corresponding status information of the resource monitoring and control devices to the resource management server via the WAN;

receive and decrypt encrypted resource control information from the resource management server via the WAN; and

process received resource control information and transmit corresponding control messages to the resource monitoring and control devices.

In particularly preferred embodiments, the resources under management are energy resources, such as electricity resources including electrical loads and generators. In alternative embodiments, the invention may be applied to other resources, such as gas and/or water.

Advantageously, the communications interface between an energy resource management client apparatus and the resource monitoring and control devices comprises one or more of a wireless communications interface, for example implementing the ZigBee protocol and/or a powerline communications interface. The resource monitoring and control devices may be adapted to plug into an ordinary domestic power outlet, or to plug into a standard circuit-breaker slot of a meter box. Each resource monitoring and control device is thus able to monitor and/or control individual domestic appliances, such as those powered from a single outlet, or an entire circuit connected to a corresponding circuit-breaker slot of the meter box. In the latter case, the resource monitoring and control devices advantageously incorporate circuit-breaker functionality, such that they become a plug-in replacement for conventional circuit-breakers.

The WAN interface is preferably an interface to the Internet. This may be, for example, a connection to a conventional residential or business broadband Internet service, either directly or via a local network and broadband router or modem.

As such, embodiments of the invention enable a small-scale site, such as a domestic residence or small-business premises to be brought under the supervision of an energy resource management system without the need for any new wiring, or modification to the current set of devices installed at the site. A key contribution to this advance lies in the provision of an energy management client apparatus, that is able to communicate with an energy management server, such as a server operated by an ESCO, and also with a plurality of local resource monitoring and control devices that may be configured, for example, to collect electricity supply metrics such as power and voltage, to open and close the circuit to which they are attached, and/or to provide circuit-breaker functionality, amongst other possibilities discussed further in the detailed description that follows.

Furthermore, the provision of an electronic access device, in the form of a secure “key” that can be fitted to the energy management client apparatus, enables the energy management client apparatus, and associated resource monitoring and control devices, to be brought under the management of an energy management server operated by a particular ESCO. In particular, the secure key device may be issued by a specific ESCO, storing its own unique identifier to identify the customer, server connection data (such as an IP address or URL) enabling the energy management client apparatus to identify and contact the energy management server, and encryption keys for securing the information transferred between the energy management client apparatus and the energy management server, which ensures that sensitive customer information cannot be intercepted, and also that the energy management client apparatus cannot be hijacked and controlled by an unauthorised remote device via the WAN.

Overall, therefore, a small-scale site can be brought under management by an ESCO without the need for any intervention at the site itself. Deployment of an energy management system embodying the invention can therefore be achieved at relatively low cost, and with minimal ongoing maintenance requirements.

In another aspect, the invention provides an electronic access device adapted for use with a resource management client apparatus having a corresponding secure key interface, the access device being configured to store information including:

a unique identifier;

resource management server connection data; and

one or more encryption keys for encrypting information transmitted between the resource management client apparatus and a resource management server,

whereby, upon interfacing of the electronic access device with the resource management client apparatus, the resource management client apparatus is enabled to implement a method including the steps of:

establishing a connection to the resource management server via a wide area network (WAN) using the resource management server connection data stored in the electronic access device;

receiving status messages from a plurality of associated resource monitoring and control devices;

processing received status messages, and encrypting and transmitting corresponding status information of the resource monitoring and control devices to the resource management server via the WAN;

receiving and decrypting encrypted resource control information from the resource management server via the WAN; and

processing received resource control information and transmitting corresponding control messages to the resource monitoring and control devices.

In a further aspect, the present invention provides a method of operating a resource consumption and control system including at least one resource management server, at least one resource management client apparatus, and a plurality of resource monitoring and control devices associated with the resource management control apparatus, the method comprising:

providing an electronic access device adapted to interface with the resource management client apparatus via a secure key interface, the electronic access device storing information including at least a unique identifier, resource management server connection data, and one or more encryption keys for encrypting information transmitted between the resource management client apparatus and the resource management server;

establishing a connection between the resource management client apparatus and the resource management server via a WAN, using the resource management server connection data stored in the electronic access device;

establishing a fully-connected data communications network comprising the resource management client apparatus and the associated resource monitoring and control devices;

the resource management control apparatus receiving status messages from the resource monitoring and control devices via the fully-connected data communications network;

the resource management client apparatus processing received status messages, and encrypting and transmitting corresponding status information of the resource monitoring and control devices to the resource management server via the WAN connection;

the resource management client apparatus receiving and decrypting encrypted resource control information from the resource management server via the WAN connection; and

the resource management client apparatus processing received resource control information and transmitting corresponding control messages to the resource monitoring and control devices via the fully-connected data communications network.

Further features and advantages of the invention will be apparent from the following detailed description of preferred embodiments, which are offered by way of example only, and should not be understood as limiting the scope of the invention as discussed in any of the preceding statements, or defined in the claims appended hereto.

### BRIEF DESCRIPTION OF THE DRAWINGS

Preferred embodiments of the invention will now be described with reference to the accompanying drawings, in which like reference numerals indicate like features, and wherein:

FIG. 1 is a block diagram of a system embodying the present invention;

FIGS. 2(a) and 2(b) illustrate two exemplary alternative client service arrangements according to embodiments of the invention; and

FIG. 3 is a flowchart illustrating a method of operating the system of FIG. 1.

### DETAILED DESCRIPTION OF PREFERRED EMBODIMENTS

In general terms, preferred embodiments of the present invention provide an energy management system that enables secure communication between a server operated by an energy service company (ESCO) and multiple client sites. Each client site is managed via an energy management client apparatus, also described herein as an energy service gateway, or “ESBox”. The ESBox, in turn, manages a self-configuring mesh network of metering, switching and circuit-breaking devices at the client site. Secure and trusted communications between the ESBox and the ESCO server is achieved using an electronic access device, also described herein as an energy service access key or “ESKey”, which is configured to securely store information including at least a unique identifier, ESCO server connection data, and one or more encryption keys. The metering, switching and circuit-breaking devices comprise resource monitoring and control devices, also described herein as mini smart meters, or “MSMs”, that are configured to establish the mesh network with the ESBox, and to exchange status and control messages via the mesh network. In preferred embodiments, the mesh network comprises a mix of powerline and wireless communications protocols.

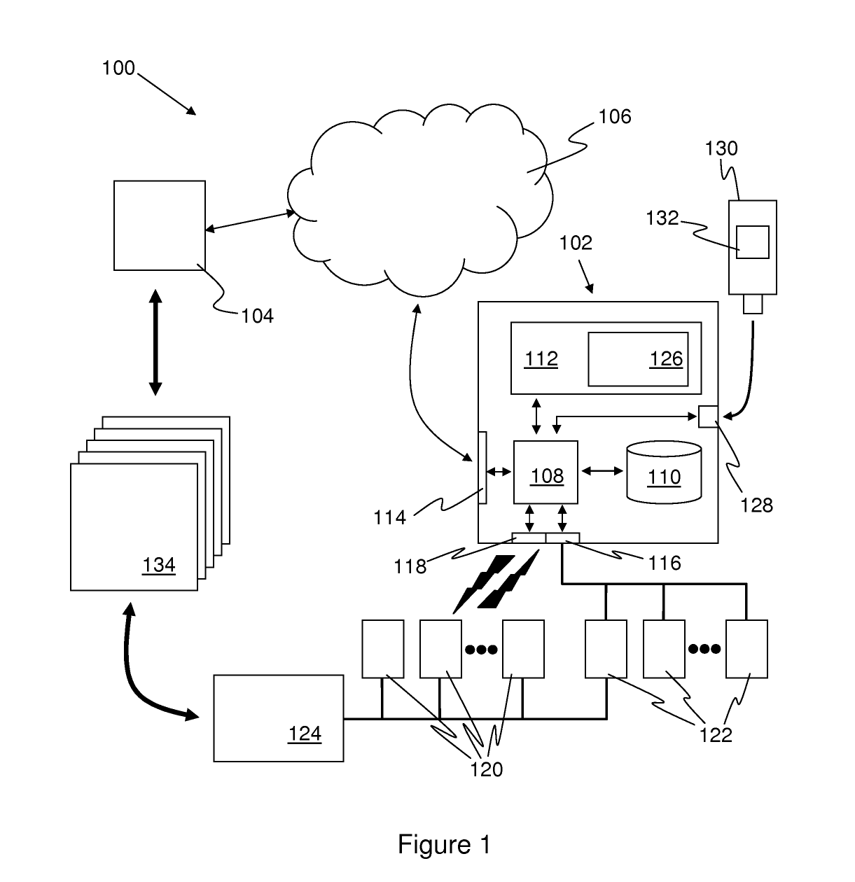

Turning now to FIG. 1, there is shown a block diagram of a system 100 embodying the present invention. The system 100 includes the ESBox energy management client apparatus 102, which communicates with a server 104 operated by a managing ESCO via a wide area network (WAN) 106, such as the Internet. The ESBox 102 is, in a straightforward implementation, a relatively conventional computing device comprising a microprocessor 108, suitable non-volatile storage 110, and volatile memory (eg random access memory) 112. Further details of these components, along with additional peripheral interfaces relevant to operation of the ESBox, are described in greater detail below. While the internal architecture of the ESBox corresponds with a conventional computing device, when embodied as a consumer product the ESBox is preferably configured as a simple and compact appliance, requiring minimal end-user configuration. Indeed, ideally the only user configuration required is to connect the ESBox to the power supply and to the Internet 106 (eg via a local broadband modem), insert an ESKey 130 issued by the ESCO, and switch on the power. Further details of how this ease of configuration may be achieved are provided below.

The ESBox apparatus 102 will now be described in greater detail. In particular, as noted above the apparatus 102 includes a microprocessor 108, interfaced to a non-volatile memory/storage device 110. The non-volatile storage device 110 may be, for example, a hard disk drive, or solid state non-volatile storage, such as flash memory. The non-volatile storage 110 is used primarily to contain programs and data required for the operation of the apparatus 102, and for the implementation and operation of various software components embodying features of the present invention. The means by which appropriate configuration and programming of the apparatus 102 may be achieved (eg relevant programming languages, software development environments, and so forth) are well-known in the art and accordingly will not be discussed in detail herein.

The ESBox apparatus 102 further includes volatile memory 112, which contains program instructions and transient data relating to the operation of the apparatus 102. The microprocessor 108 is also able to communicate via the Internet 106 through a network interface 114, which may be a wired interface (eg Ethernet) or wireless interface (eg WiFi) in communication with a broadband modem or router that provides Internet access. The microprocessor 108 is further able to communicate via a powerline communications interface 116, and a local wireless communications interface 118, which may be, for example, a ZigBee interface.

The local communications interfaces 116, 118, enable the ESBox apparatus 102 to communicate with a plurality of resource monitoring and control devices, ie MSMs 120, 122. As shown in the exemplary system 100, communications with MSMs 120 is via the wireless communications interface 118, while communication with MSMs 122 is via the powerline communications interface 116. In general, each MSM may be configured for wireless, eg ZigBee communications, powerline communications, or both. Various embodiments of the MSMs are possible, within the scope of the present invention. For example, one type of MSM may be implemented that is configured to be fitted in a standard circuit-breaker slot of a meter box. This type of MSM is able to monitor power usage (ie voltage and current) on a corresponding circuit at the client site, and also incorporates circuit-breaker functionality in order to disconnect the circuit in case of excessive current draw. An alternative type of MSM is configured to plug into a standard power socket, for example enabling a corresponding device or appliance to be plugged in via a “piggyback” arrangement. This type of MSM is able to monitor power usage, ie voltage and current, by the piggybacked device or appliance, and may also include circuit-breaker functionality. It is also possible that some appliances, including refrigerators, dishwashers, air conditioners, and others, may be designed to incorporate suitable MSMs, although this is not essential for implementation of embodiments of the invention. Advantageously, however, such “integrated” MSMs may able to access device-specific functionality, such as reduced power operating modes, enabling further improvements in energy management.

Importantly, all MSMs include switching functionality, ie the ability to disconnect power to the attached circuit, appliance or device.

Each MSM 120, 122 is connected (typically via the site's power distribution network and meter box) to the electricity grid 124.

Turning again to the ESBox 102, at any given time, the volatile memory 112 contains a body of program instructions 126 for execution by the microprocessor 108. The program instructions 126 embody various software-implemented features of the invention, including communications with the MSMs 120, 122, and with the ESCO server 104.

The ESBox 102 further includes an interface 128 via which an electronic access device, or ESKey 130, may be operably connected to the ESBox 102. The ESKey interface 128 may be, for example, a USB interface, a smart card interface, or the like.

Each ESKey 130 includes internal memory and electronics 132 providing secure storage of information. In particular, the information content of the ESKey is established by an issuing ESCO, and cannot be readily accessed by a user, being made available only to an ESBox 102 once the ESKey 130 has been connected to the interface 128. Typically, the information content of the ESKey 130 is encrypted, and both the ESBox 102 and the ESKey 130 are configured to be capable of verifying each other's authenticity before any of the information contained on the ESKey 130 is decrypted and made available to the ESBox microprocessor 108. In some embodiments, for example, the ESKey 130 may be implemented as a Trust Extension Device (TED), as described in Nepal, S. Zik, J., Hwang, H. and Moreland, D., “Trust Extension Device: Providing Mobility and Portability of Trust in Cooperative Information Systems,” OTM 2007, Part I, ONCS 4083, Meersman, R. and Tari, Z. (Editors), Springer-Verlag Berlin Heidelberg: 2007, pages 253 to 271. The foregoing publication is hereby incorporated herein in its entirety by reference.

The information stored within the memory/electronics 132 of the ESKey 130 includes at least the following elements:
a unique identifier, that enables the ESKey 130 and, by extension, the ESBox 102, to be identified and authenticated by the ESCO server 104;
connection information associated with the ESCO server 104, which may be, for example, an Internet Protocol address or a URL; and
one or more encryption keys that may be used to encrypt information transmitted between the ESBox 102 and the ESCO server 104 via the Internet 106.

The importance of establishing trusted communications between the ESBox 102 and the ESCO server 104, and of encrypting communications therebetween, will be appreciated in view of the fact that the ESCO server 104 is able to issue instructions to the ESBox 102 for operation of the MSMs 120, 122, and also that messages transmitted from the ESBox 102 to the ESCO server 104 may include sensitive information relating to current and/or historical energy usage at the client site. The provision of the ESKey 130, which is central to the establishment of trust and secure encryption of information, is thus central to the operation of preferred embodiments of the invention.

The final component of the system 100, as shown in FIG. 1, is the energy supply sector 134, which includes generators, distributors, regulators and so forth. The ESCOs may purchase electricity from within this sector on behalf of their clients, and in turn act as energy retailers while also providing energy management services for those clients. Alternatively, ESCOs may operate outside the normal electricity market, for example by selling services based upon their management of client energy resources and passing on a portion of the income as payment to their clients. While those clients continue to purchase their electricity from a retailer within the energy supply sector 134 at normal tariffs, overall cost savings are achieved due to the efficiencies resulting from ESCO management of energy usage and/or income derived from the services provided by the ESCO to the energy supply sector 134.

The ability for an ESCO to manage energy consumption at small sites, such as domestic residences and small businesses, via the ESBox 102, enables these smaller consumers to obtain benefits in terms of cost savings and energy efficiencies, that have previously only been available to large energy consumers for which the infrastructure and operating costs were justifiable.

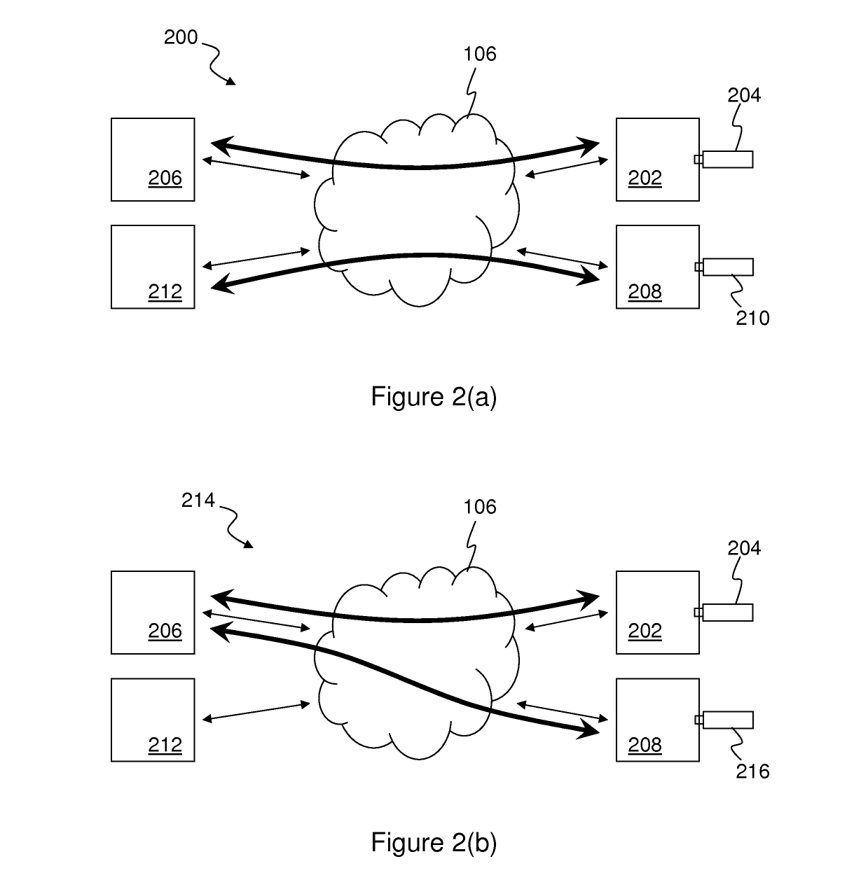

FIGS. 2(a) and 2(b) depict schematically two different scenarios, illustrating the benefits available by use of the ESKey 130. In both examples 200, 214, there are shown first and second client ESBox apparatus 202, 208, along with two separate management servers 206, 212, which are operated by different ESCOs. In the first example 200, shown in FIG. 2(a), each client is served by a different one of the two ESCOs. The first client has an ESKey issued by the first ESCO, which operates server 206. The information stored on the ESKey 204 identifies the client, and facilitates communication between the ESBox 202 and the ESCO server 206. The second client has an ESKey 210 that has been issued by the second ESCO, operating server 212. Accordingly, the information stored on the ESKey 210 identifies the second client, and facilitates communication with the second ESCO server 212.

In the second scenario 214, shown in FIG. 2(b), the second client is also a customer of the first ESCO, operating server 206. Accordingly, the second client has a different ESKey 216, which has now been issued by the first ESCO. The information stored on the ESKey 216 identifies the second client to the first ESCO, and facilitates communications between the ESBox 208 and the first ESCO server 206.

From the examples 200, 214 illustrated in FIGS. 2(a) and 2(b), it can be appreciated that the use of portable electronic access devices, such as the ESKeys, provides a further benefit to the ESCOs and their clients. In particular, the ESBox may be a standard (ie commodity) appliance, along with the MSMs, that can be installed, without the need for any specialist knowledge, skills, qualifications or authority, at any site, such as a small business or residential site. Upon subscribing to the services of an ESCO, the client is provided with a corresponding ESKey that is simply plugged into the client's ESBox. The client site is then able to be brought immediately under management by the ESCO, without the need for any on-site visit or installation. The cost of the ESBox 102 and the MSMs 120, 122, may be relatively low, and accordingly the initial capital outlay is minimal. As such, embodiments of the invention are capable of making the provision of ESCO services to small sites an economically viable reality.

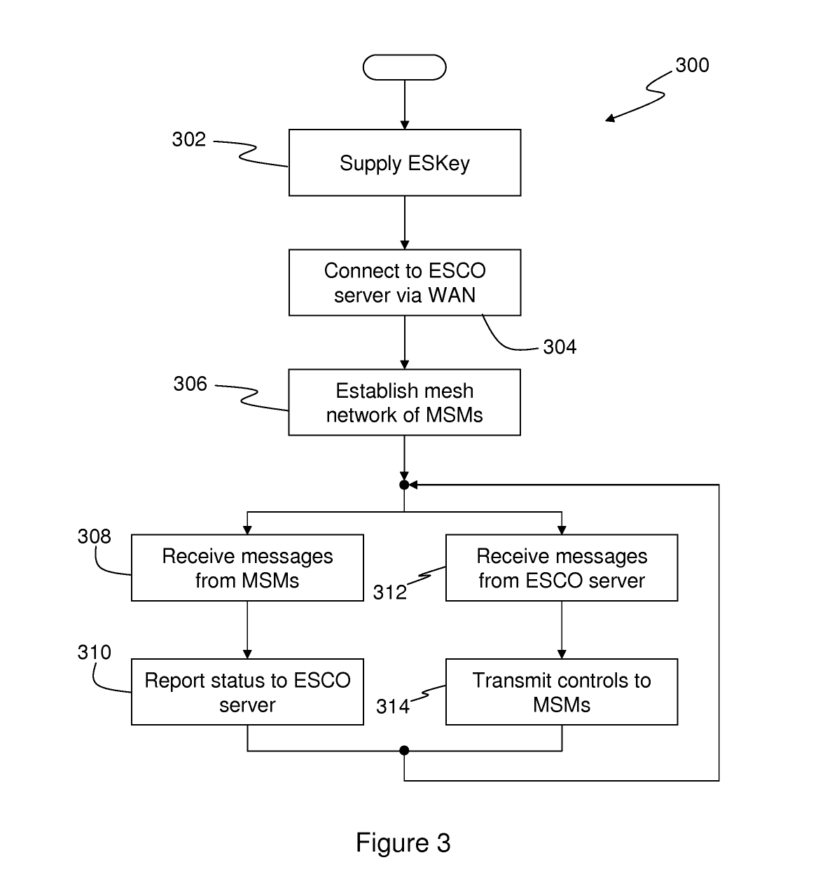

Turning now to FIG. 3, there is shown a flowchart 300 illustrating a method of operating the system 100. At step 302, a client site subscribes to ESCO services, and is supplied with a corresponding ESKey. The ESKey is fitted into the client ESBox, which is then able to connect to the ESCO server via the Internet, at step 304. At around the same time (the order of the steps not being critical) a mesh network comprising the ESBox 102 and the various MSMs at the site 120, 122, is established at step 306. For wireless communications between the ESBox 102 and MSMs 120, based upon the ZigBee protocols, the ESBox 102 is configured as a ZigBee Coordinator (ZC). The ESBox 102 is thus able to initiate formation of an ad hoc network, and stores information about the network, also acting as a trust centre and repository for security keys relating to communication amongst the nodes in the ZigBee network. Preferably, the MSMs 120 are kept as simple, and low-cost, as possible, and accordingly are typically ZigBee End Devices (ZEDs).

Similarly, the ESBox 102 communicates with MSMs 122 via the powerline communications interface 116, and incorporates these MSMs into the mesh network. Similar algorithms may be used in order to establish the powerline network as are used to form the ZigBee wireless network. Preferably, the different network protocols are bridged by the ESBox 102 at a common application layer, enabling seamless communication with MSMs using both forms of communication. It will be appreciated that communication with MSMs need not be limited to wireless and powerline communications, although these are considered to be the most practical, cost-effective and universally applicable. Some MSMs may be configured with multiple communications interfaces (eg both wireless and powerline), and such MSMs may advantageously also provide bridging functionality within the ad hoc network.

In the preferred embodiment, each MSM 120, 122 is uniquely paired with the ESBox 102 such that communication with other devices will not be permitted in the absence of authentication by the ESBox 102. Pairing between an ESBox 102 and one or more MSMs 120, 122 may be factory-set, eg such that an ESBox is sold as a set with a number of paired MSMs. Alternatively, pairing may be established at installation, for example by near-simultaneous activation of a pairing function of the ESBox and each MSM, such as is employed within Bluetooth™ protocols. As will be appreciated, a requirement for initial pairing of devices enhances security of the ad hoc network, and ensures that the necessary trust amongst devices required for ZigBee secure communications is established.

Once the connection to the ESCO server, and the network of MSMs has been established, normal ongoing operation of the ESBox 102 commences. The ESBox 102 is generally involved in two activities, as illustrated in the flowchart 300. Steps 308 and 310 relate to the gathering and communication of information from MSMs, while steps 312 and 314 relate to controlling the operation of MSMs, in accordance with requirements received from the ESCO server 104.

In particular, at step 308 the ESBox 102 receives messages sent by the MSMs. Such messages generally contain status information, such as whether or not a circuit, appliance or device is active, along with current and/or historical energy use. Status information may also include warning and/or overload conditions, or indications that a circuit-breaker has been activated. The ESBox 102 receives and records the status information, and processes it for reporting back to the ESCO server 104, at step 310. Information reported back to the server 104 may include current and/or historical energy utilisation of individual appliances or devices, specific circuits, and/or the entire client site. The information may also include predicted energy consumption, eg based upon specific site policies and/or past consumption. All of this information may be used by the ESCO server 104 in order to manage the energy consumption at the site, and to obtain cost and efficiency benefits for the client.

In the other direction, at step 312 the ESBox 122 receives messages from the ESCO server 104. These messages may include control information, such as requests and/or requirements for particular devices to be deactivated (eg air conditioners), or for overall site consumption to be reduced, during specific periods of time. The extent to which an ESCO server 104 may be able to require the deactivation of appliances and/or reduction of consumption, will typically be established through a specific service policy between the client and the ESCO. Clients may, for example, agree to temporary consumption restrictions, capped at a certain maximum duration over an agreed period (such as one year), in return for a reduction in tariffs. These types of “demand-response” agreements enable the ESCO to manage overall consumption of its clients, advantageously reducing the demand during those periods.

The ESBox 102 receives and processes the messages sent by the ESCO server 104, and issues appropriate corresponding control messages to the MSMs, as and when required, at step 314.

In various embodiments, the infrastructure represented by the system 100, and corresponding method 300, may be used to develop and deliver a wide variety of different services, benefiting the end-consumer, and/or the supply sector 134. A non-exhaustive listing of potential services is set out below.

Demand Side Response

The term “demand side response” refers to an agreement by consumers to reduce energy consumption, under suitable contractual terms, at times of peak demand. That is, in exchange for agreeing to reduce consumption when requested, consumers receive a reduction in tariffs and/or payment or rebates in exchange for such reductions. For example, a consumer may agree to a total of up to 25 hours per year in contracted demand response, which the serving ESCO can effectively “sell” to suppliers 134, enabling them to reduce reserve capacity within the supply system.

A demand side approach for optimising residential energy use, along with suitable algorithms, is described in Wang, C., de Groot, M., and Merendy, P., “A Service-Oriented System for Optimizing Residential Energy Use,” IEEE International Conference on Web Services (ICWS), 2009, pages 735 to 742, the disclosure of which is hereby incorporated herein in its entirety by reference. Other approaches to demand side response are also possible, and for example the approach taken in relation to small businesses is likely to be different to that for residential sites.

Electricity Bill Auditing

Data gathered from the MSMs may be collated by the ESBox 102 and/or the ESCO server 104, for comparison with the client's electricity account. In particular, when variable, demand-based, tariffs are employed, it is difficult for end-consumers to verify the correctness of bills issued by their energy retailers. The ability to perform detailed reconciliation via the ESCO service may therefore be highly desirable.

Electricity Bill Estimation

Since the ESBox 102 and/or ESCO server 104 are able to maintain ongoing records of energy usage, using meter information provided by the MSMs, it is possible to provide the client with a current estimate of unbilled charges at any time, based upon the collated metering data and corresponding tariff information. The client may be able, for example, to log into a web-based interface to their ESCO service account, and from there to view estimates of unbilled electricity charges.

Virtual Time-of-Use Billing

While each ESCO client may have a separate supply contract with their energy retailer, which includes associated tariffs, a separate off-market contract may be established between the client and the ESCO for a “virtual” time-of-use tariff. In particular, the ESCO may establish a contract with the client under which the client is paid to shift demand away from either peak grid demand times, or from high electricity spot market prices. The virtual time-of-use tariffs may provide for more fine-grained control of electricity consumption than variable tariffs applicable under the client's contract with their energy retailer.

Consumption Optimisation

In cases where an energy supplier has implemented a dynamic pricing tariff, the ESCO server 104 may assist the client in optimising consumption, by scheduling device usage in a manner that reduces overall energy costs. This may be more practical and effective on large sites, such as commercial buildings, where there are larger numbers of devices across which the scheduling may be performed.

Detailed Electricity Usage Monitoring

As an extension to electricity bill estimation, ESCO clients may also be able to review detailed information, at any time, in relation to their past and current electricity usage. For example, detailed graphs and/or tables summarising energy usage may be supplied for hourly, daily, weekly, monthly, and so forth, periods. These services may be delivered, for example, via a web-based account.

Suspicious Electricity Usage Alarms

The ESCO may be able to provide a client with alerts, for example via SMS, email, telephone or other means, in the event of suspicious, abnormal, and/or unexpected energy usage. For example, clients may be enabled to set up a timetable of anticipated electricity usage ranges for metered devices and circuits. Alternatively, the ESBox 102 and/or the ESCO server 104 may be configured to learn the client's typical usage over a period of time. The client may then be alerted whenever usage occurs outside the anticipated ranges. Specific events may also be detected, and alerts generated, such as an oven circuit showing a reading during periods when a residence is normally unoccupied, or in the event that a short circuit is detected.

Power Quality Monitoring

The MSMs may be capable of measuring energy usage in terms of fundamental quantities such as voltage and current. Thus the MSMs will be aware when, for example, the supply voltage deviates from acceptable levels. This information may then be reported back to the ESCO server 104, which is able to collate information from multiple sites in order to monitor power quality in different geographical regions. Power quality data may be communicated to relevant operators within the supply sector, to assist in the identification and correction of faults.

Grid Fault Detection

In a further level of service beyond power quality monitoring, an ESCO may use information gathered from a range of sites not only to identify possible power quality issues, but also to facilitate specific fault detection and diagnosis on behalf of suppliers. Specific analysis of power quality readings may, for example, enable an ESCO to identify and diagnose the existence of a faulty local transformer within a specific geographical area. This information can then be passed on to the relevant supplier.

Remote Circuit/Device Power Switching

Since the ESCO server 104 is able, via the ESBox 102, to activate and/or deactivate individual circuits, appliances or devices, connected to MSMs 120, 122, a facility may be provided to enable a client to remotely operate such circuits and devices, for example via their ESCO web account interface. Of course, the ability to activate a particular device will also be dependent upon the settings of that device.

Disconnect Distributed Generation from Grid

While the majority of this description has provided examples in which the various devices connected to MSMs 120, 122, are loads (ie energy-consuming devices), this is not a limitation of the system, and MSMs may also be connected to local generation devices, such as photovoltaic solar panels, or combined heat and power (CHP) units. Such distributed generation devices feed unused generated energy back into the grid. Corresponding MSMs may also be operable to disconnect the distributed generation units from the grid. This may be provided, for example, as a service to the grid operator, which may wish to disconnect generation devices that are causing problems, or prior to grid maintenance.

Emergency Load Shedding

A client may be enabled, or required under contract, to identify specific devices or circuits comprising discretionary loads, such as plasma TVs, air conditioners and so forth. The ESCO server 104 is then able to facilitate emergency load shedding by disconnecting such devices, upon request of the supply sector 134, as a means to avoid a total blackout.

Green Energy

The ESCO server 104 may further be able to participate in coordination of the use of electricity for discretionary loads (eg spa baths, pool pumps and so forth) with the availability of higher levels of renewable energy penetration into the grid. Such loads may have flexible operating times, such that they may be activated, for example, during peaks of solar energy generation. The ESCO server 104 may utilise information available to it from other client sites that have local generation capacity, such as roof-mounted solar panels, and not just renewable generation provided by the generating companies within the supply sector.

Frequency Control Ancillary Services (FCAS)

In some embodiments, it may be possible for the ESCO to aggregate small loads at client sites into tradeable FCAS facilities. This may be achieved either by using specialised MSMs that can be armed for FCAS response, or through very reliable connections.

Renewable Energy Certificate (REC) Auditing

MSMs that are attached to renewable energy certificate—(REC) bearing equipment may be used to monitor the actual efficiency benefits provided by a particular installation. In this regard, monitoring could be ongoing, or may be used for a sufficient period to enable the REC to be given an accurate rating.

Virtual Retailing

In accordance with the embodiment of the invention described above with reference to FIGS. 1 to 3, an ESCO client is also typically a customer of a particular energy retailer. That is, a retailer bills the client for net electricity consumption, in accordance with the retailer's normal tariffs as contracted with the client from time-to-time. Any economic benefits that the ESCO is able to achieve on behalf of the client, for example by selling contracted demand response to suppliers, are passed on by way of payments from the ESCO to the customer. The customer may consider this to be an inefficient or inconvenient arrangement, since they are then required to deal with both their chosen retailer and the ESCO.

Accordingly, in some embodiments the ESCO may become an electricity retailer, responsible for all customer billing. It is envisaged that the ESCO would be able to negotiate cheaper electricity supply, by aggregating consumer accounts and requesting bulk discounts, or by offering to use the control facility to flatten demand. In turn, the ESCO provides highly competitive tariffs to its clients, and is able to incorporate economic returns, eg from sale of demand response capacity, either in the form of tariff reductions, and/or direct rebates on client accounts.

Within typical regulatory environments, such as that which applies in Australia, virtual retailing based upon the general system architecture 100 shown in FIG. 1 requires that the MSMs 120, 122 be certified as legal metering devices.

Meter Reading

A further benefit that may be available if the MSMs can be certified as legal electricity metering devices, is that the ESCO could then offer an automated meter reading service to retailers. However, even if the MSMs are not certified, retailers may obtain an “estimated” meter reading from the ESCO based upon MSM readings, which may be used as a basis for interim accounts between actual on-site meter readings. This may enable the requirement for on-site readings to be reduced, for example from quarterly to yearly.

Sub-Metering

In further embodiments the system 100 may be used to enable sub-metering to be performed at sites in which multiple consumers share a single physical meter. This could include, for example, serviced offices, boarding houses, and so forth. In particular, the electricity usage of individual consumers may be determined based upon their corresponding MSM readings. These may be reconciled with total electricity usage for the site, as measured by the on-site physical meter.

Smart Meter Backhaul Backup

The energy services infrastructure 100 may be used, in some embodiments, to offer grid operators a backup communication network in systems employing smart meters. That is, in the event of a communication failure, or where communications infrastructure is incomplete, on-site smart meters may connect to the wireless and/or powerline communications networks managed by the ESBox 102, which can then route smart meter communications via the Internet 106 to the ESCO server 104, from which they can be passed on to the grid operators.

Supply Contract Repurchase

The infrastructure 100 may also, in some embodiments, enable the ESCO to participate in and/or facilitate the formation of repurchase agreements. For example, the ESCO may be able to identify a pool of consumers having a relevant consumption characteristic, such as the use of air conditioning. In these circumstances, it would be possible to trade shares in the supply contracts for this pool of consumers on a repurchase agreement, prior to an expected heatwave. The seller obtains the benefit of a guaranteed income over the period, while the buyer effectively takes a position on the effect of the heatwave on consumption and spot market prices.

Electricity Price Hedging

At present, for example in the Australian National Electricity Market, generators can hedge against low spot market prices by becoming retailers and thus benefiting from the higher floor price of residential supply tariffs. Conversely, retailers can hedge against high spot market prices by also having a generating business. In some embodiments, the infrastructure 100 may be utilised to enable securitising of blocks of retail accounts, thereby allowing generators to get the same hedging benefit without needing to run their own retail business. This would also allow retailers to diversify risk by developing a more balanced portfolio of supply contracts.

Carbon Accounting

Using the metering facilities provided by the MSMs, the exact greenhouse gas footprint of a site may be calculated by correlating usage with the type of generation used to supply consumption of energy. Sites with similar overall consumption may have different greenhouse gas footprints, due to different consumption patterns which alter the mix of generation capacity supplying different proportions of the power consumed. Similarly, different types of local generation facilities (eg solar panels or CHP) make power available for local use during different time periods. Accordingly, a carbon accounting service based upon actual MSM readings could make appropriate adjustments to the carbon rating of a site reflecting its actual overall greenhouse gas footprint.

Carbon Offset Programs

The system 100 further enables ESCOs to maintain subscription services which enable consumers to automatically offset their greenhouse gas footprint. For example, a customer participating in a carbon accounting scheme, such as described above, may authorise the ESCO to automatically purchase offset credits on their behalf, in respect of any net carbon emissions.

Electric Vehicle Management

Vehicle-to-grid (V2G) services enable improved management of power stored in electric vehicle batteries. For example, an electric vehicle may have some tens of kilowatt hours stored in its batteries. Preferably, vehicles are charged during periods of relatively low demand, and/or during periods in which high levels of renewable energy are available. Unneeded stored energy can be sold back to the grid at premium rates during periods of peak demand.

In some embodiments of the system 100, MSMs associated with electric vehicle charging points can be used to monitor flow of power to and from electric vehicle batteries. This may be used to enable more-efficient and cost-effective V2G services, whereby customers may be able to maximise income by providing grid support, and also to minimise costs for charging electric vehicles from the grid. The service may also include identifying charging stations where electric vehicles can participate in V2G services while away from home.

Household Consumption and Device Configuration Planning

The ESCO may analyse data received from client sites to generate an energy flow model for those sites, which will vary with different configurations of appliances and devices. By providing an online facility enabling clients to interact with the energy flow model, and thereby understand the impact of different device configurations and usage patterns on energy costs, as well as greenhouse gas emissions, consumers are empowered to improve energy efficiency, reduce emissions, and save money.

Generation Curtailment

In the presence of multiple local generation devices within a particular area, electricity distributors may wish to limit customer feed-in electricity in order to avoid a net export of electricity from a corresponding sub-station. Many components of the traditional electricity distribution network have been designed for power flow occurring in a single direction only. At least in the short-to-medium term, it may be more cost-effective for a network operator to pay an ESCO service fee, plus a feed-in tariff on unused electricity, rather than upgrade such network elements. The ESCO can control individual MSMs associated with generating devices in order to curtail feed-in electricity. Payment for the electricity generated, but not delivered to the grid, is then passed to the consumer via the ESCO, rather than as a “real” feed-in tariff on the consumer's electricity bill.

Virtual Generator

When an ESCO has a sufficiently large number of clients with generating devices under management, it may be in a position to coordinate large numbers of these distributed electricity assets into a “virtual power station”, which is able to participate in the electricity market. Smaller collections will be better suited to over-the-counter (OTC) contracts.

### CONCLUSION

Preferred embodiments of the invention are able to provide a self-configuring universal energy management solution. Such embodiments satisfy a need to bring every electricity-consuming or -producing site under management, without requiring local electrical expertise or modification to any appliances, circuits or devices. In particular, preferred embodiments of the invention provide the only complete energy management system known to the inventors that is suitable for use by small business and residential customers, and which can be installed without any new wiring or modification to the current set of circuits, appliances and devices at the site. Prior art solutions to single-site electricity management require either modifications to the existing wiring, specialised device control hardware, or offer only partial monitoring and control of site electricity consumption.

While preferred embodiments of the invention have been disclosed herein, other variations and extensions falling within the scope of the invention will be apparent to persons skilled in the art. For example, while presently preferred embodiments are designed to operate primarily in the electricity distribution system, other types of resource monitoring and control devices (analogous to the MSMs in the electricity management system) may be deployed that are configured to monitor and/or manage other utility services, such as gas and water supplies. Accordingly, embodiments of the invention may be readily adapted for the management of other resources, or indeed to the integrated management of multiple resources, including electricity, gas and water utilities. The overall scope of the invention is therefore not limited to the preferred embodiments, but is as defined in the claims appended hereto.

1. A resource management client apparatus comprising:
an interface to a wide area network (WAN) facilitating connection to a resource management server;
at least one communications interface configured to communicate with a plurality of resource monitoring and control devices associated with the resource management client apparatus;
a secure key interface configured to receive an electronic access device that securely stores information including at least a unique identifier, resource management server connection data, and one or more encryption keys for encrypting information transmitted between the resource management client apparatus and the resource management server,
wherein the resource management client apparatus is configured to:
establish a connection to the resource management server via the WAN, using the resource management server connection data stored in the electronic access device;
receive status messages from the resource monitoring and control devices via the communications interface;
process received status messages, and encrypt and transmit corresponding status information of the resource monitoring and control devices to the resource management server via the WAN;
receive and decrypt encrypted resource control information from the resource management server via the WAN; and
process received resource control information and transmit corresponding control messages to the resource monitoring and control devices.

2. The resource management client apparatus of claim 1 which is an energy management client apparatus configured to communicate with a plurality of associated energy resource monitoring and control devices, and to connect via the WAN with an energy management server.

3. The apparatus of claim 2 wherein the communications interface between the energy management client apparatus and the resource monitoring and control devices comprises one or more of a wireless communications interface and a powerline communications interface.

4. An energy management system comprising a client apparatus according to claim 2, and one or more resource monitoring and control devices which are adapted to plug into a domestic power outlet.

5. An energy management system comprising a client apparatus according to claim 2, and one or more monitoring and control devices which are adapted to plug into a standard circuit-breaker slot of a meter box.

6. The system of claim 5 wherein the resource monitoring and control devices incorporate circuit-breaker functionality.

7. An electronic access device adapted for use with a resource management client apparatus having a corresponding secure key interface, the access device being configured to store information including:
a unique identifier;
resource management server connection data; and
one or more encryption keys for encrypting information transmitted between the resource management client apparatus and a resource management server,
whereby, upon interfacing of the electronic access device with the resource management client apparatus, the resource management client apparatus is enabled to implement a method including the steps of:
establishing a connection to the resource management server via a wide area network (WAN) using the resource management server connection data stored in the electronic access device;
receiving status messages from a plurality of associated resource monitoring and control devices;
processing received status messages, and encrypting and transmitting corresponding status information of the resource monitoring and control devices to the resource management server via the WAN;
receiving and decrypting encrypted resource control information from the resource management server via the WAN; and
processing received resource control information and transmitting corresponding control messages to the resource monitoring and control devices.

8. A method of operating a resource consumption and control system including at least one resource management server, at least one resource management client apparatus, and a plurality of resource monitoring and control devices associated with the resource management control apparatus, the method comprising:
providing an electronic access device adapted to interface with the resource management client apparatus via a secure key interface, the electronic access device storing information including at least a unique identifier, resource management server connection data, and one or more encryption keys for encrypting information transmitted between the resource management client apparatus and the resource management server;
establishing a connection between the resource management client apparatus and the resource management server via a WAN, using the resource management server connection data stored in the electronic access device;
establishing a fully-connected data communications network comprising the resource management client apparatus and the associated resource monitoring and control devices;
the resource management control apparatus receiving status messages from the resource monitoring and control devices via the fully-connected data communications network;
the resource management client apparatus processing received status messages, and encrypting and transmitting corresponding status information of the resource monitoring and control devices to the resource management server via the WAN connection;
the resource management client apparatus receiving and decrypting encrypted resource control information from the resource management server via the WAN connection; and
the resource management client apparatus processing received resource control information and transmitting corresponding control messages to the resource monitoring and control devices via the fully-connected data communications network.
